(19) United States
(12) Patent Application Publication
(10) Pub. No.: US 2022/0371914 A1
(43) Pub. Date: Nov. 24, 2022

(54) Docking Station for Mobile Deionization Trailers and Related Methods

(71) Applicant: Evoqua Water Technologies LLC, Pittsburgh, PA (US)

(72) Inventors: PETER M. KEIS, Loves Park, IL (US); ROBERT BRUCE TEMPLE, Katy, TX (US); TRAVIS L. GABLE, Porter, TX (US)

(73) Assignee: Evoqua Water Technologies LLC, Pittsburgh, PA (US)

(21) Appl. No.: 17/608,011

(22) PCT Filed: Apr. 28, 2020
(86) PCT No.: PCT/US2020/030226

§ 371 Date: Nov. 1, 2021

Related U.S. Application Data
(60) Provisional application No. 62/841,537, filed on May 1, 2019.

(51) Int. Cl. C02F 1/00; B01D 61/46; B01D 61/52; B01D 61/54; C02F 1/42

(52) U.S. Cl. CPC C02F 1/008; B01D 61/46; B01D 61/52; B01D 61/54; C02F 1/42; B01D 2311/24; B01D 2313/90; C02F 2103/02

(57) ABSTRACT

A docking station at a service site fluidly connectable to a mobile water treatment system having one or more deionization units comprises a fluid inlet configured to receive processed water from the mobile water treatment system and a fluid outlet configured to deliver the processed water to a point of use. The docking station also comprises a monitoring system configured to monitor at least one water quality parameter of the processed water, and a processor configured to receive the monitored water quality parameter and communicate with a central monitoring system disposed remotely from the station regarding the monitored water quality parameter.

### RELATED APPLICATIONS

This application claims priority under 35 U.S.C. § 119(e) to U.S. Patent Application Ser. No. 62/841,537, titled “DOCKING STATION FOR MONITORING, CONTROL AND PREDICTIVE EXCHANGE OF MOBILE DEIONIZATION TRAILERS,” filed on May 1, 2019, which is herein incorporated by reference in its entirety for all purposes.

### BACKGROUND

### Field of Disclosure

Aspects and embodiments disclosed herein are directed generally to methods and apparatus for monitoring, controlling, and maintaining water treatment systems, and in particular to systems and methods of monitoring the condition of ion exchange-based water treatment systems.

### Discussion of Related Art

In industrial plants, deionized (DI) water facilitates water and wastewater recycling and adds efficiency and life extension to boiler and steam processes. Deionized water is used to pretreat boiler feed water to reduce scaling and energy use and to control deposition, carryover and corrosion in the boiler system. As such, DI water is an essential element in boiler water recycling. Deionized water can pretreat cooling tower make-up water to help reduce scaling and reduce energy use in power plants, petroleum refineries, petrochemical plants, natural gas processing plants, food processing plants, semiconductor plants, and other industrial facilities.

Flow meters, conductivity and resistivity meters, temperature sensors, pH sensors and hydrogen sulfide sensors, for example, along with other scientific instruments are widely used in many remote locations for a variety of purposes including monitoring the condition of a water purification system. It is often necessary for workmen to physically visit the remote sites to monitor the flow meters or other instruments (e.g., samplers) to gather data. Multiple site visits in numerous locations is a challenging, labor intensive, and expensive task. Ensuring that each site is operational, and that maintenance or service is regularly scheduled provides for obtaining accurate and reliable data.

### SUMMARY

In accordance with aspect of the present disclosure, there is provided a docking station at a service site fluidly connectable to a mobile water treatment system having one or more deionization units. The docking station comprises a fluid inlet configured to receive a processed water from the mobile water treatment system and a fluid outlet configured to deliver the processed water to a point of use, a monitoring system configured to monitor at least one water quality parameter of the processed water, and a processor configured to receive the monitored water quality parameter and communicate with a central monitoring system disposed remotely from the docking station regarding the monitored water quality parameter.

In some embodiments, the processor is further configured to record the at least one monitored water quality parameter and provide the record to the central monitoring system.

In some embodiments, the processor is further configured to uniquely identify the mobile water treatment system. The processor may be further configured to provide to the central monitoring system a representation of a remaining treatment capacity associated with the uniquely identified mobile water treatment system.

In some embodiments, the monitoring system is further configured to monitor at least one of flow rate, conductivity, temperature, and pressure of the processed water. The monitoring system may be further configured to monitor a silica concentration of the processed water.

In some embodiments, the docking station further comprises a feed water inlet configured to deliver feed water to the mobile water treatment system and a second monitoring system configured to monitor at least one water quality parameter of the feed water. The at least one water quality parameter of the feed water may include at least one of turbidity, oxidation-reduction potential, flow rate, and conductivity. The docking station may be configured to suspend delivery of the feed water to the mobile water treatment system responsive to one or more quality parameters of the feed water being outside of an acceptable range. The processor may be further configured to determine a predicted time until exhaustion of at least one deionization unit based on the remaining treatment capacity of the at least one deionization unit of the mobile water treatment system and the at least one water quality parameter of the feed water. The processor may be further configured to determine the predicted time until exhaustion or the remaining treatment capacity of the at least one deionization unit based further on the feed water flow rate or the processed water flow rate. The processor may be configured to communicate the predicted time until exhaustion or the remaining treatment capacity of the at least one deionization unit to the central monitoring system.

In some embodiments, the central monitoring system is configured to compare the predicted time until exhaustion to a transit time for delivery of a second mobile water treatment system to the docking station at the service site. The processor may be configured to send a request for replacement of the mobile water treatment system with the second mobile water treatment system. The processor may be configured to send a request for connection of the second mobile water treatment system to a second docking station located at the same service site as the docking station.

In some embodiments, the docking station is configured to suspend delivery of the processed water in response to one or more water quality parameters being outside of an acceptable range. The processor may be configured to control a second docking station to deliver processed water from a second mobile water treatment system connected to the second docking station to the point of use responsive to suspending delivery of the processed water from the mobile water treatment system.

In some embodiments, the docking station is configured to deny a request for delivery of the processed water from the mobile water treatment system to the point of use until a valid user login and a valid mobile identification has been received. The docking station may include a user interface and may be configured to only accept a request for delivery of the processed water from the mobile water treatment system to the point of use responsive to a valid user login and a valid mobile water treatment system identification being received through the user interface.

In accordance with another aspect, there is provided a water treatment system. The water treatment system comprises one or more docking stations in fluid communication with one or more respective points of use, and a central monitoring system remote from and in communication with the one or more docking stations. The one or more docking stations each include a fluid inlet configured to receive a processed water from a uniquely identifiable mobile deionization trailer and a fluid outlet configured to deliver the processed water to the one or more points of use, a monitoring system configured to monitor one or more water quality parameters of the processed water, and a processor configured to communicate with the central monitoring system and receive data regarding remaining treatment capacity of deionization units disposed in the mobile deionization trailer.

In some embodiments, the central monitoring system is configured to provide the data regarding the remaining treatment capacity of the deionization units of one of the uniquely identifiable mobile deionization trailers based on the one or more monitored water quality parameters. The processor may be configured to determine a predicted time until exhaustion of at least one of the deionization units based on the data regarding a remaining treatment capacity of deionization units, one or more quality parameters of feed water provided to the one of the uniquely identifiable mobile deionization trailer and measured by the monitoring system, and flow rate of one of the feed water or of the processed water. The one or more uniquely identifiable mobile deionization trailers may include geolocation systems and may be further configured to communicate their respective location to the central monitoring system. The processor may be configured to receive information regarding a location of a second mobile deionization trailer from the remote monitoring system and to send a request for delivery of the second mobile deionization trailer based on the predicted time to exhaustion of the deionization units and the location of second mobile deionization trailer.

In accordance with another aspect, there is provided a method of facilitating water treatment at a point of use. The method comprises installing a docking station at a site including the point of use, the docking station including a fluid inlet configured to receive processed water from a mobile deionization trailer and a fluid outlet configured to deliver the processed water to the point of use, a monitoring system configured to monitor one or more water quality parameters of the processed water, and a processor configured to communicate with a central monitoring system and receive data regarding remaining treatment capacity of deionization units disposed in the mobile deionization trailer, and enabling communication between the stationary docking station and the central monitoring system.

In some embodiments, the method further comprises connecting the mobile deionization trailer to the docking station. In some embodiments, the method comprises providing the docking station with a unique identifier of the mobile deionization trailer. In some embodiments, the method comprises exchanging information between the docking station and the central monitoring system regarding remaining treatment capacity of deionization units disposed in the mobile deionization trailer. In some embodiments the method comprises providing treated water to the point of use from the mobile deionization trailer through the docking station.

In accordance with another aspect, there is provided a method of providing or retrofitting a docking station for mobile deionization trailers each of which having uniquely identifiable information at a site having a point of use for processed water from the uniquely identifiable mobile deionization trailers. The method comprises installing a monitoring system configured to monitor one or more water quality parameters of the processed water in the docking station, installing a second monitoring system configured to monitor one or more water quality parameters of feed water to be provided to the mobile deionization trailers in the docking station, and installing a processor configured to communicate with a remote monitoring system and receive data regarding remaining treatment capacity of deionization units disposed in the mobile deionization trailers and to determine a predicted time to exhaustion of the deionization units in the docking station.

In accordance with another aspect, there is provided a system for providing treated water comprising a first mobile asset having a first group of water treatment units disposed thereon, and a first data interface configured to be accessible by a docking station, the first group of water treatment units configured to receive inlet water to be treated and deliver treated water to the docking station, the first data interface configured to be accessible by the docking station and provide identification information of the first mobile asset.

In some embodiments, the first mobile asset is further configured to provide information pertinent to its current location.

In some embodiments, the system further comprises a second mobile asset having a second group of water treatment units disposed thereon, and a second data interface configured to be accessible by the docking station, the second group of water treatment units configured to receive inlet water to be treated and deliver treated water to the docking station, the second data interface configured to be accessible by the docking station and provide identification information of the second mobile asset.

In some embodiments, the at least a portion of the identification information of the first mobile asset includes type and capacity relative to each of the water treatment units of the first group.

In some embodiments, the docking station comprises a first communication system configured to exchange data with the first data interface of the first mobile asset and a first monitoring system configured to monitor at least one of a water quality parameter of the water to be treated and a water quality parameter of the treated water. The docking station may be further configured to determine a remaining capacity of one or more of the water treatment units of the first group based on one or more of the monitored water parameters. The docking station may comprise a second communication system configured to exchange information regarding the identification information and the remaining capacity of one or more water treatment units of the first group with a central monitoring system. The first communication system may be further configured to exchange information regarding the identification information and the remaining capacity of one or more water treatment units of the first group with a central monitoring system.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1A illustrates a service facility including a docking station for a mobile water treatment system;

FIG. 1B illustrates a service facility including multiple docking stations for mobile water treatment systems;

FIG. 1C illustrates a service facility including multiple mobile water treatment systems coupled to the same docking station;

FIG. 1D illustrates a plurality of service facilities each in communication with a remote central monitoring system;

FIG. 2 is a piping and instrumentation diagram (P&ID) of an example of a docking station for mobile deionization trailers;

FIG. 3 illustrates a control system of an example of a docking station for mobile water treatment systems;

FIG. 4 depicts an example of a docking station for mobile water treatment systems;

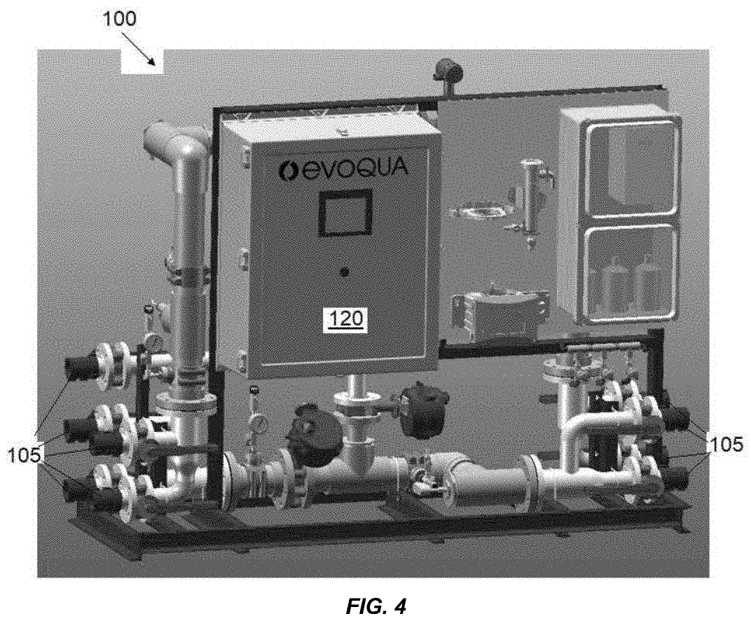

FIG. 5 is an overall process flow diagram for operation of a docking station for mobile water treatment systems;

FIG. 6 is a flow diagram of a delivery process of a mobile water treatment system;

FIG. 7 is a flow diagram of a service process utilizing a docking station for mobile water treatment systems;

FIG. 8 is a flow diagram of an exhaustion process for a docking station for mobile water treatment systems; and

FIG. 9 illustrates components within an example mobile water treatment trailer.

### DETAILED DESCRIPTION

Aspects and embodiments disclosed herein are not limited to the details of construction and the arrangement of components set forth in the following description or illustrated in the drawings. Aspects and embodiments disclosed herein are capable of other embodiments and of being practiced or of being carried out in various ways.

Some implementations of systems for supplying purified or deionized (DI) water to a facility or point of use may include fixed treatment apparatus, for example, carbon filtration columns, ion exchange columns, actinic radiation (e.g., ultraviolet light) disinfection apparatus, microfilters or reverse osmosis (RO) filters and associated pumps and monitoring equipment. Upon exhaustion or responsive to scheduled maintenance, service personnel may travel to the facility or point of use to perform maintenance on the fixed treatment apparatus, for example, to replace exhausted ion exchange media in ion exchange columns.

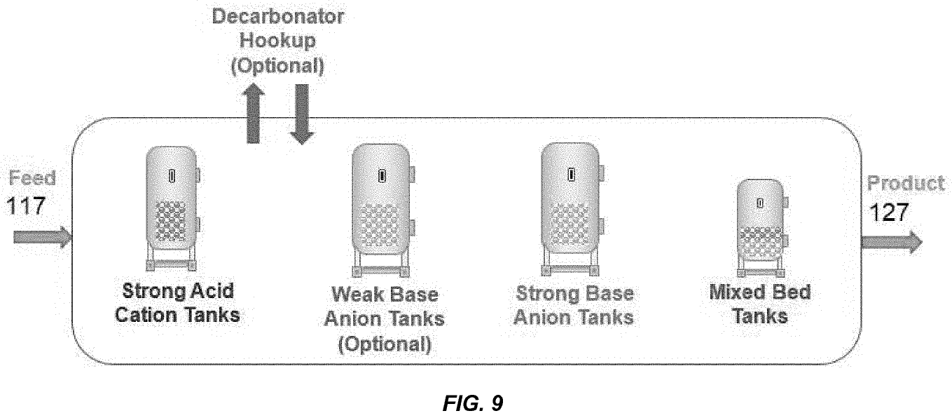

In other implementations fixed treatment apparatus for supplying DI water to a facility or point of use may be supplemented by or replaced by mobile water treatment systems. The mobile water treatment systems may include one or more or all of the treatment apparatus used to treat influent water to produce DI water and provide the DI water to the facility or point of use. The mobile water treatment systems may be in the form of mobile trailers including inlets for receiving water to be treated and outlets for delivering the treated water (e.g., DI water) to the facility or point of use. For example, as illustrated in FIG. 9, an example of a mobile water treatment trailer may receive a feed stream 117 and treat it with one or more of strong acid cation ion exchange media system, a weak base anion exchange media system, a strong base ion exchange media system, and a mixed bed ion exchange media system to produce a treated product 127. Responsive to exhaustion or a prediction of upcoming exhaustion of ion exchange media beds or responsive to scheduled maintenance of other components of the water treatment system, e.g., a mobile trailer at a facility, the mobile trailer may be disconnected from the water inlets and outlets at the facility and brought to a maintenance facility. Another mobile trailer brought to the facility and connected to continue providing water treatment service at the facility.

In accordance with aspects and embodiments disclosed herein, intelligent water purification apparatus that incorporate predictive features for maintenance and billing can be applied to mobile trailers. Large consumers of DI water often have variations in demand and rely on mobile deionization services to handle peaks and valleys in consumption. Although for some there are infrequent events that increase demand, others have variations in demand daily or weekly and retain mobile deionization capacity on a nearly continuous basis. In these implementations, the effort required to monitor mobile deionization performance, request exchanges and assure the necessary available capacity is more than desired. Inability to predict exhaustion of capacity results in excess capacity being retained on site and unavailable for other uses. The traditional design and delivery of mobile deionization assets focuses on individual service runs or exchanges, rather than optimizing the long-term supply of deionized water for a specific use case. Instrumentation, controls and telemetry on individual mobile deionization trailers are often insufficient to measure desired parameters, prevent incorrect operation and relay information about field operation in a way that is easy to interpret.

Aspects and embodiments of intelligent docking stations as disclosed herein may help to address one or more of these problems. The intelligent docking stations may be utilized as interfaces for mobile water treatment system, for example, mobile water treatment trailers (also referred to simply as “trailers” herein) to provide water to be treated to the trailers and receive treated water (e.g., DI water, also referred to as processed water or product herein) from the trailers for distribution to facilities at which the docking stations are located. Aspects and embodiments of intelligent docking stations as disclosed herein may include instruments not available on most trailers to help eliminate manual monitoring and sampling of process streams. Docking stations as disclosed herein may operate predictive models that use information about the water to be treated (also referred to as feed water herein) and the connected mobile trailer to predict exhaustion of treatment apparatus such as ion exchange columns in the trailer. In some embodiments, the docking stations use current and historical data to create notifications sufficiently in advance of exhaustion, such that replacement trailers can be delivered as needed and excess standby capacity can be reduced. In some embodiments, the docking stations have redundant capabilities to alarm and stop the flow of water if the mobile deionization trailer feed or processed water is of insufficient quality. Operation of a docking station as disclosed herein includes a human-machine interface which guides and logs on-site operator interactions. Data specific to the local operation is easy to find in one place and interpret for continuous process improvement.

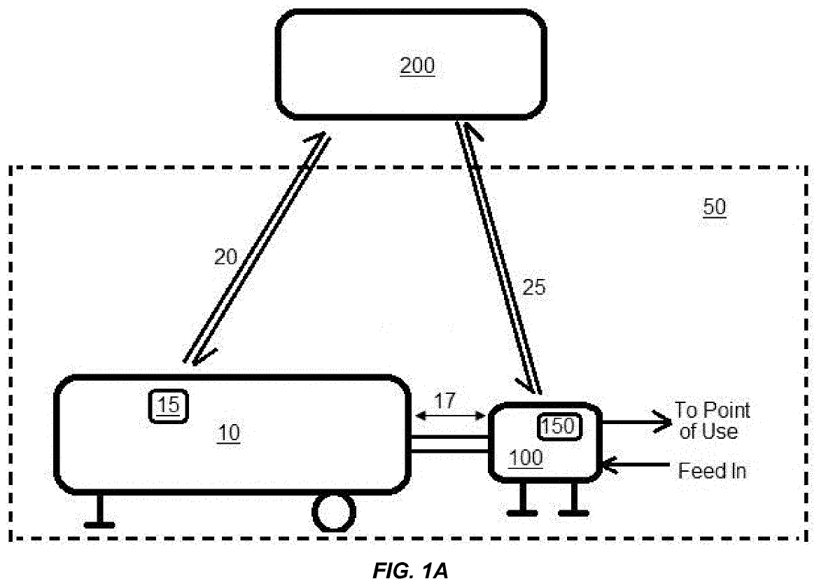

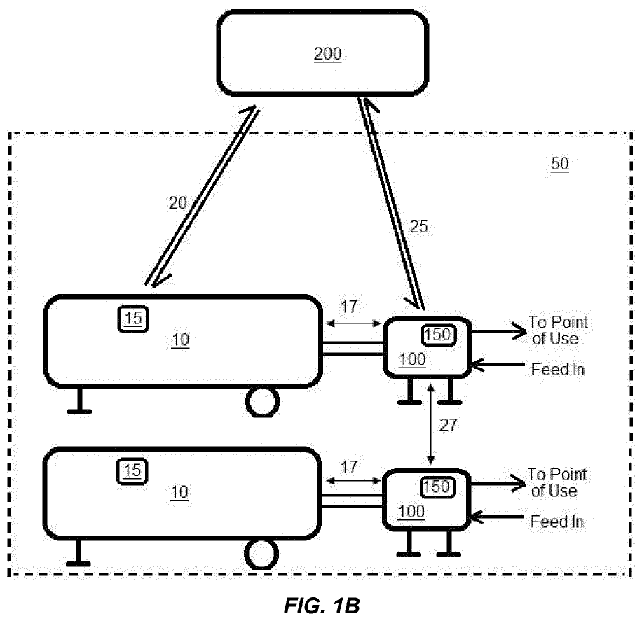

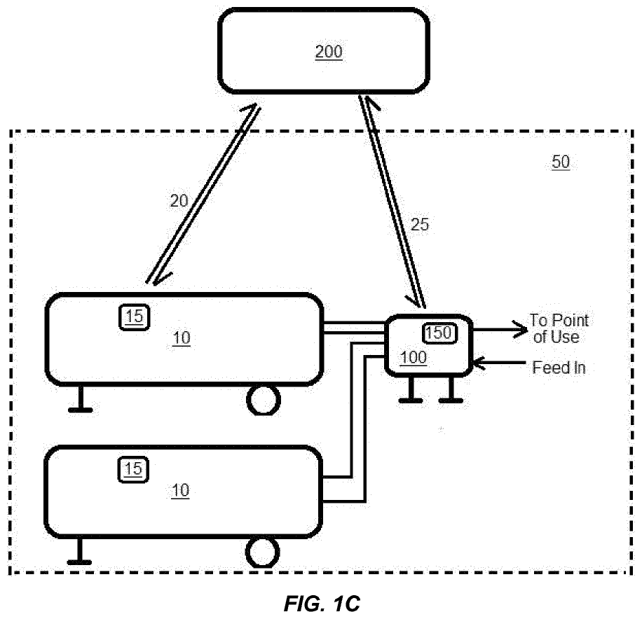

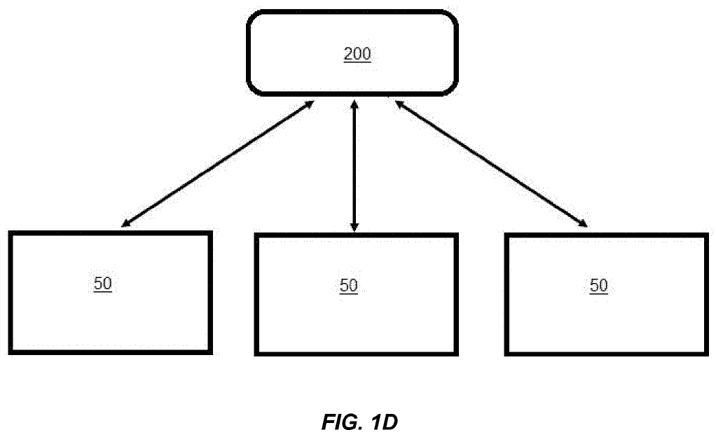

FIG. 1A illustrates an example of a mobile water treatment system in the form of a mobile trailer 10 (as an embodiment of a mobile water treatment system) connected to an example of a docking station 100 at a service site or facility 50 (the terms service site and facility being used synonymously herein). The mobile trailer 10 may include a geolocation system 15, for example, a GPS system that provides information regarding time and location of the mobile water treatment system. The mobile water treatment system may include at least one or typically a plurality of treatment units, for example, one or more ion exchange units, one or more reverse osmosis, one or more ultrafiltration units, and/or other water treatment or separation units. In a typical configuration, the docking station 100, or a controller 150 thereof, may be in communication with a central monitoring system such as a remote monitoring facility 200 via one or more wired or wireless communication links 25, for example, a cellular communication link using a proprietary messaging protocol, and may exchange information with the remote monitoring facility 200 regarding, for example, operation and status of the docking station, the configuration, operation and status of the mobile trailer 10, the configuration, operation, and status of each or any of the one or more of the treatment units of the mobile water treatment system, one or more parameters of feed or product water quality measured in the docking station 100, orders for replacement trailers, and other information as discussed in further detail below. Communications between the mobile trailer 10 and docking station 100 may be provided by a communication link 17 which may be, for example, an Ethernet communications link or a wireless (e.g., BlueTooth® wireless communication, Wi-Fi, WLAN, etc.) communications link. In an alternative configuration, the trailer 10 may be in communication via, for example, a wireless communication link 20 such as a cellular or wireless internet network with the remote central monitoring facility 200 and may provide information regarding the location of the trailer and identifying information regarding the trailer to the central monitoring system.

FIG. 1B illustrates an embodiment pertinent to one or more aspects of the invention relevant to a service site or facility 55 that includes a plurality, and as exemplarily illustrated, two docking stations 100. Different mobile water treatment systems 10 may be connected to the different docking stations 100. One of the docking stations 100 may be a master that can control operation of the others of the plurality of docking stations, e.g., the second docking station 100 via a wired (e.g., Ethernet) or wireless (e.g., BlueTooth® wireless communication, Wi-Fi, WLAN, etc.) communication path 27. The second docking station 100 may thus communicate with the first docking station 100 and with the remote central monitoring system 200 through the first docking station 100 as illustrated in FIG. 1B. In other embodiments the second docking station 100 may also or alternatively communicate directly with the remote central monitoring station 200. The provision of a plurality of docking stations at a single service site may be advantageous in that it provides for redundancy in case one of the docking stations experiences an error or is in need or service and/or to provide reliable or continuous delivery of processed water when a first mobile water treatment system 10 connected to a first of the docking stations 100 while a second mobile water treatment system 10 connected to a second of the docking stations 100 is replaced or serviced.

In other embodiments, a service site may include more than two docking stations and/or more than one mobile water treatment system 10 connected to one or more respective docking stations 100, for example, as illustrated in FIG. 1C.

As illustrated in FIG. 1D, multiple service sites or facilities 50 each including one or more docking stations 100 in fluid communication with one or more respective points of use, as illustrated FIGS. 1A and 1B, may each be concurrently in communication with the central monitoring facility 200. In such configuration, each of the docking stations 100 can exchange data with the central monitoring facility continuously with constant communication; continually with regular, repeated or intermittently communication, but not necessarily constantly; or on demand, when communication is established responsive to a prompt by any of one of the docking stations or the central monitoring facility.

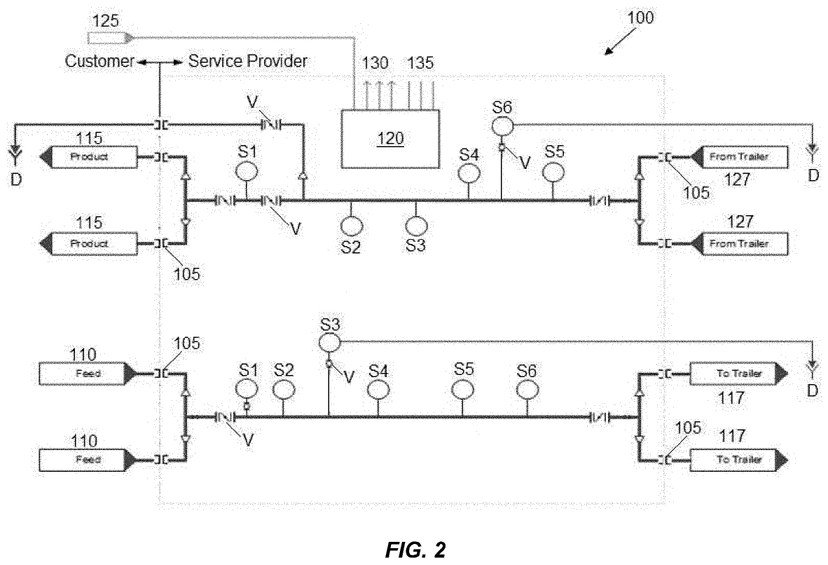

A piping and instrumentation diagram (P&ID) for an example of an intelligent docking station 100 as disclosed herein is illustrated in FIG. 2. The docking station 100 includes water fittings 105 to connect to a feed water supply 110 and receive feed water to be treated from a facility at which the docking station is located, at a service site. The docking station 100 also includes water fittings 105 that form a feed water inlet configured to connect to and deliver the feed water to be treated to a mobile water treatment system, for example, a mobile trailer (mobile water treatment system) connected to the docking station as streams 117. The docking station 100 also includes a water fitting 105 that forms a fluid inlet configured to receive processed water from a mobile water treatment system, for example, a mobile trailer connected to the docking station as streams 127. Further water fittings 105 may form fluid outlets configured to deliver the processed water to a point of use, for example, to connect to a treated water inlet at the facility and deliver the treated water product (e.g., DI water) 115 to the facility. The water fittings 105 may be industry standard fittings, for example, 2.5-inch fire hose fittings. The docking station 100 may include multiple feed water inlet fittings 105 to receive feed water from multiple sources, multiple product water outlet fittings 105, and may have multiple fittings 105 to deliver feed water and receive treated product water from multiple trailers. In some embodiments, a single docking station 100 may connect to and control operation several different trailers. Further, as explained in further detail below, one docking station 100 may act as a master and communicate with other ancillary docking stations at a facility to control operation of and receive information regarding additional trailers connected to the ancillary docking stations.

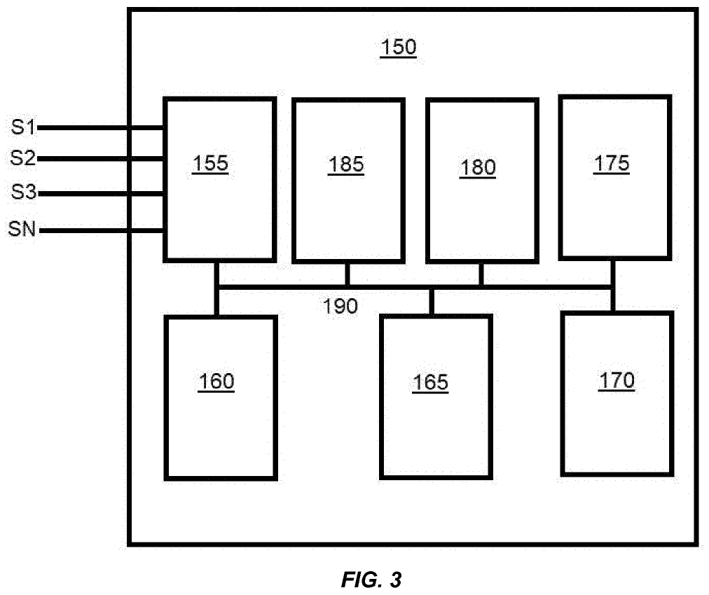

The docking station 100 may further include an enclosure 120 for a control system that receives power from a power supply 125 of the facility at which the docking station 100 is installed. The controller 150 (See FIGS. 1A-1C and 3) may be located within the enclosure 120 and may provide or control one or more output power lines 130 to provide power to other components of the docking station, for example, one or more sensors or valves, and one or more communication lines 135 to provide for communication between other components of the docking station, for example, one or more sensors or valves, with a user interface, with other docking stations, or with a remote monitoring system or facility 200.

The docking station 100 may include a monitoring system configured to monitor at least one water quality parameter of the feed water provided to the docking station 100 and/or treated or processed water from a trailer 10 connected to the docking station 100. The monitoring system may include multiple sensors for monitoring parameters of both the feed water supplied to the docking station 100 and processed product water produced by the mobile trailers from the feed water. The sensors included in the docking station 100 may include multiple sensors that are not available on previously existing mobile water treatment trailers. The monitoring system may include a first monitoring system configured to monitor at least one water quality parameter of the processed product water and a second monitoring system configured to monitor at least one water quality parameter of the feed water.

The processed water sensors of the first monitoring system may include one or more pressure sensors S1, one or more flow rate sensors S2, one or more oxidation-reduction potential (ORP) sensors S3, one or more turbidity sensors S4, one or more conductivity and/or pH (e.g., acidity or alkalinity) sensors S5, and one or more chemical concentration sensors S6 that monitor the concentration of one or more chemical species, for example, dissolved carbon dioxide, dissolved oxygen, reactive silica, etc. The monitoring system may be configured to monitor at least one of flow rate, alkalinity, conductivity, oxidation reduction potential, and silica concentration of the processed water from a trailer 10 connected to the docking station 100. In some embodiments in which multiple docking stations are provided at a facility, for example, a master docking station and ancillary docking stations, a chemical concentration sensor such as a reactive silica concentration sensor may be provided on only a subset, for example, a single of the docking stations, and receive sample streams to be monitored from others of the docking stations. The feed water sensors of the second monitoring system may also include, for example, one or more pressure sensors S1, one or more flow rate sensors S2, one or more oxidation-reduction potential (ORP) sensors S3, one or more turbidity sensors S4, one or more conductivity and/or pH sensors S5, and one or more chemical concentration sensors S6 that monitor the concentration of one or more chemical species, for example, dissolved carbon dioxide, dissolved oxygen, reactive silica, etc.

The order and specific placement of the sensors illustrated in FIG. 2 is one example. In other implementations the different sensors may be placed in different locations or orders upstream or downstream of one another.

The docking station 100 may include multiple valves V, for example, diaphragm valves, ball valves, needle valves, or other types of valves. The valves V may be manually operable or automatically operable under control of the controller 150 of the docking station to regulate and/or halt flow of feed or product water through the docking station or to direct feed or product water to drain D responsive to detection of one or more parameters of the feed or product water, for example, turbidity, conductivity, ORP, concentration of silica or other chemical species, etc. being outside of a desired or acceptable range. The valves V may also provide for water to be flowed through portions of the treatment units and fluid conduits of the docking station and to drain for rinsing or during maintenance activities. The docking station 100 is configured to suspend delivery of the processed water in response to one or more water quality parameters being outside of an acceptable range. The acceptable range would typically be dependent on water quality requirements of the point of use.

The controller 150 of the docking station, illustrated in functional block diagram form in FIG. 3, may include at least one sensor interface 155 that is in communication with one or more of the sensors (S1, S2, S3, . . . SN) of the docking station 100. One or more control interfaces 160 may provide commands to operate one or more valves, pumps, or other control apparatus of the docking station 100 and/or trailers 10 connected to the docking station 100. The control interface(s) 160 may also be used to send control signals to one or more ancillary docking stations. A processor 165 may receive signals from the sensor interface(s) 155 and send signals to the control interface(s) 160 responsive to analysis of readings from the one or more sensors provided by the sensor interface(s) 155. The processor 165 may send and receive signals to and from one or more communication interfaces 170, for example, one or more wired or wireless modems or cellular network interfaces to communicate information regarding operations or status of the docking station 100 and/or trailers 10 connected to the docking station 100, for example, one or more monitored water quality parameters of the feed and/or product water passing through the docking station 100 to a remote monitoring system or facility 200 (See FIG. 1A). The docking station 100 may send requests for service or for replacement trailers through the communication interface(s) 170 to the remote monitoring system or facility 200. The docking station 100 may receive operating commands or software updates from the remote monitoring system or facility 200 through the communication interface(s) 170. The docking station 100 may receive data regarding operation parameters or measured water quality parameters from an ancillary docking station through the communication interface(s) 170. The controller 150 may also include one or more forms of memory 175, for example, a hard disk, solid-state memory, RAM, EEPROM, etc. that records control programming for the processor 165 and maintains a record of measured parameters from the sensors of the docking station. A power supply 180 which may include external power from a power source at a facility at which the docking station is installed and/or which may include battery backup may be included in the controller and provide power for operation of the components of same and/or of the various control apparatus or sensors of the docking station 100 and/or trailer 10. The controller 150 may further include, or alternatively be in communication with a user interface 185, for example, a graphical user interface, keyboard, or other form of user interface for receiving commands or displaying information to a local user. Each of the components of the controller may be coupled via one or more communication busses 190.

The controller 150 of the docking station may include security features that prevent or at least inhibit unauthorized operation. For example, the controller may only allow a user to operate the docking station 100 if the user enters a valid user identification and, optionally, a valid mobile water treatment system identification as well. In some implementations, the user enters the user identification and mobile water treatment system identification through the user interface 185 of the controller 150. In other implementations, the mobile water treatment system may transmit an identification number or code directly to the controller 150 via, for example, Wi-Fi or BLUETOOTH™ short range wireless communications. The controller 150 may send the entered user identification and mobile water treatment system identification to the central monitoring system 200 for verification or consult a record in the memory 175 of the controller itself for verification of valid identifications. In some embodiments, if the identification of the mobile water treatment system is of a mobile water treatment system that is no longer in service or that, via information provided by a geolocation system of the mobile water treatment system, the central monitoring system 200 or docking station 100 knows is at a different location from the service site at which the docking station 100 is located, access to control of the docking station may be denied. The docking station may thus be configured to deny a request for delivery of processed water from a mobile water treatment system to a point of use at a service site until a valid user login and a valid mobile water treatment system identification has been received.

In some embodiments, the processor 165 of the controller 150 may cause one or more water quality parameters monitored by the monitoring system of the docking station to be recorded locally in the memory 175. The processor 165 may periodically or continuously also provide the record of the one or more water quality parameters to the central monitoring system 200, for example, via the communication interface(s) 170.

Different mobile water treatment trailers 10 may be uniquely identified or identifiable, for example, by serial number or other unique identification number or code. In some embodiments, the processor 165 is configured to uniquely identify a mobile water treatment system, for example, a mobile water treatment trailer 10 connected to the docking station 100. The processor may uniquely identify the mobile water treatment system by, for example, receiving an indication of a identifier such as serial number or other unique identification number or code entered into the user interface 185 by an operator when the mobile water treatment system is connected to the docking station 100 or activated.

The processor 165 may utilize one or more algorithms to determine a remaining treatment capacity of a uniquely identified mobile water treatment system connected to the docking station 100, as described in further detail below, and may periodically or continuously provide to the central monitoring system 200 a representation of a current remaining treatment capacity associated with the uniquely identified mobile water treatment system, for example, via signals transmitted to the central monitoring system 200 through the communication interface(s) 170 of the controller 150.

The processor 165 may further utilize one or more algorithms to determine a predicted time until exhaustion of at least one unit operation of the mobile water treatment system, e.g., a deionization unit of the mobile water treatment system, for example a trailer 10 connected to the docking station 100, based on the remaining treatment capacity of the at least one deionization unit and at least one water quality parameter of the feed water. The processor 165 may determine the predicted time until exhaustion based solely on and/or further on the feed water flow rate and/or the processed water flow rate. Algorithms for determining the remaining capacity and remaining time until exhaustion of a deionization unit of a water treatment system are described in detail further below. Alternate algorithms for determining the remaining capacity and remaining time until exhaustion of a deionization unit of a water treatment system are described in detail in U.S. patent application Ser. No. 16,358,190, which is incorporated by reference herein in its entirety. The processor 165 may communicate the predicted time until exhaustion of the at least one deionization unit to the central monitoring system 200, for example, via signals transmitted to the central monitoring system through the communication interface(s) 170 of the controller 150.

In some embodiments, it may be desirable to provide uninterrupted service of processed water delivery to a service site. Accordingly, if a treatment unit, for example, a deionization unit of a mobile water treatment system connected to a docking station 100 at the service site is nearing exhaustion, it may be desirable to request that a second or replacement mobile water treatment system be delivered to the facility prior to exhaustion of the treatment unit of the current mobile water treatment system connected to the docking station 100 at the service site. The processor 165 of the controller 150 may be configured to send a request for replacement of the mobile water treatment system with the second mobile water treatment system. Alternatively, in service sites including multiple docking stations, the processor may be configured to send a request for connection of the second mobile water treatment system to a second docking station 100 located at the same service site as the docking station 100. After the second mobile water treatment system arrives and is connected to the second docking station 100, the processor 165 of the controller 150 of the docking station 100 may control the second docking station 100 to deliver processed water from the second mobile water treatment system connected to the second docking station to a point of use at the service site responsive to suspending delivery of the processed water from the mobile water treatment system.

In some embodiments, one or both of the processor 165 of the controller 150 and/or the remote central monitoring system is configured to compare the predicted time until exhaustion to a transit time for delivery of a second mobile water treatment system, for example, a second mobile deionization trailer, to the docking station 100 at the service site. The request for replacement of the mobile water treatment system with the second mobile water treatment system may thus be sent early enough so that the second mobile water treatment system will arrive at the service site prior to exhaustion of the treatment unit of the mobile water treatment system connected to the docking station 100 at the service site, taking into account the transit time for the delivery of the second mobile water treatment system to the service site. The processor 165 may be configured to receive information regarding a location of the second mobile deionization trailer from the remote central monitoring system 200 and to send a request for delivery of the second mobile deionization trailer based on the predicted time to exhaustion of the deionization unit or units of the mobile water treatment system and the location of second mobile deionization trailer. In some configurations, the central monitoring system includes information regarding the operation status, availability and/or condition of the second or alternative mobile treatment system. For example, the central monitoring system may receive information that a uniquely identified second mobile treatment system has become available upon regeneration or replacement of ion exchange media in the one or more unit operations, typically all unit operations, of such second mobile treatment system. Likewise, the respective availability of the other or further uniquely identifiable mobile treatment systems is recorded or stored at the central monitoring system. In some cases, a current location is contemporaneously associated with the respective current status information of each of the mobile treatment systems in a fleet of mobile treatment systems. Upon receipt of a request from a docking station for a scheduled replacement or service of a currently in-service mobile treatment system, the central monitoring system can thus identify a listing of candidate second mobile treatment systems in the fleet of mobile treatment systems for replacement of the currently in-service mobile treatment system based on status information. A specific mobile treatment system can then be selected as a second mobile treatment system from the list of available systems as a replacement by, for example, selecting the mobile system with a shortest distance or a least amount of transport time to the service site of the currently in-service mobile treatment system. In other cases, a second mobile treatment system can be selected if it has an associated transport time to the service site that represents at most the remaining duration until exhaustion of the current, first mobile treatment system.

Aspects and embodiments disclosed herein include methods to implement one or more aspects of the water treatment systems disclosed above. In some implementations an operator of a site including a point of use for processed water may wish to equip the site to receive the processed water from a mobile deionization trailer. A method of equipping the site to receive the processed water from a mobile deionization trailer may include installing a docking station 100 at the site including the point of use. As discussed above, the docking station 100 may include a fluid inlet, for example, a water fitting 105, configured to receive processed water from a mobile deionization trailer and a fluid outlet, for example a second water fitting 105, configured to deliver the processed water to the point of use. The docking station may further include a monitoring system configured to monitor one or more water quality parameters of the processed water, for example, via any of sensors S1-S6 illustrated in FIG. 2. A processor 165 included in a controller 150 of the docking station 100 is configured to communicate with a central monitoring system 200 and receive data regarding remaining treatment capacity of deionization units disposed in the mobile deionization trailer. The method further includes enabling communication between the stationary docking station 100 and the central monitoring system 200, for example, via the communication interface(s) 170 of the controller 150. Once the docking station 100 is installed, a mobile deionization trailer 10 may be connected to the docking station 100 via the water fittings 105. An operator may access the user interface 185 of the controller 150 and provide the docking station with a unique identifier of the mobile deionization trailer. The docking station 100 may exchange information with the central monitoring system 200 regarding remaining treatment capacity of deionization units disposed in the mobile deionization trailer and provide treated water to the point of use from the mobile deionization trailer through the docking station 100.

Aspects and embodiments disclosed herein include methods for retrofitting a docking station at a site having a point of use for processed water from uniquely identifiable mobile deionization trailers. The method may include installing a monitoring system configured to monitor one or more water quality parameters of the processed water in the docking station. The monitoring system may include one or more of the sensors S1-S6 on the processed water side of the docking station illustrated in FIG. 2 and a sensor interface 155 in communication with the one or more sensors S1-S6 and with a processor 165 of a controller 150 of the docking station. The method may further include installing a second monitoring system configured to monitor one or more water quality parameters of feed water to be provided to the mobile deionization trailers in the docking station. The second monitoring system may include one or more of the sensors S1-S6 on the feed water side of the docking station illustrated in FIG. 2. If not already present, the method may further include installing the processor 165 in the controller 150 of the docking station. The processor 165 may be programmed or otherwise configured to communicate with a remote monitoring system 200 and receive data regarding remaining treatment capacity of deionization units disposed in the mobile deionization trailers and to determine a predicted time to exhaustion of the deionization units.

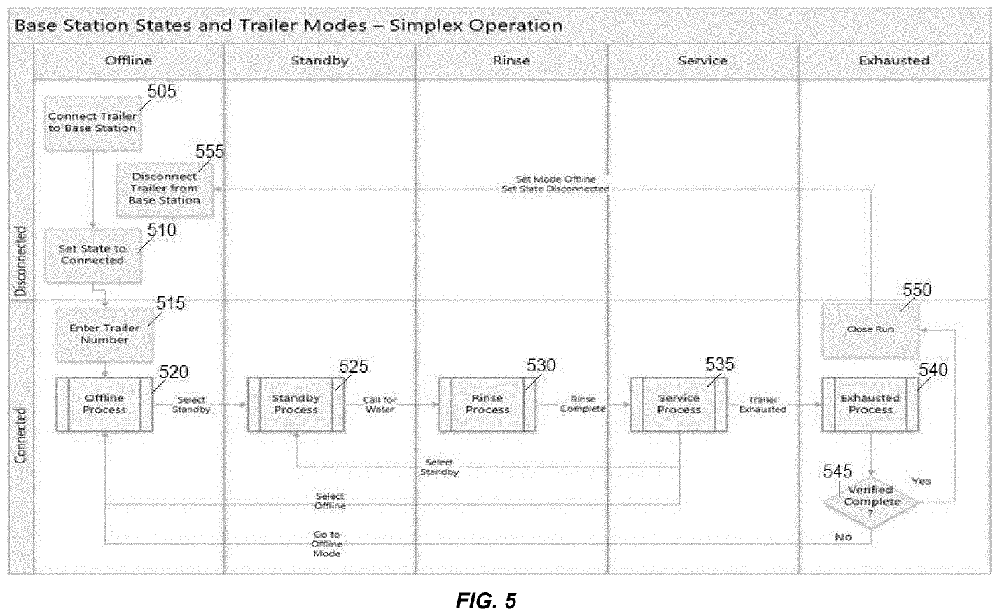

A process flow diagram for operation of a water treatment system at a service site as disclosed herein is illustrated in FIG. 5. In act 505, an operator connects a mobile water treatment trailer to a docking station. In act 510, the operator accesses the user interface of the docking station and sets a status of the trailer to “Connected.” The operator may be required to enter the trailer number into the user interface of the docking station in act 515. At this point, the trailer is still in an offline mode (Offline Process 520). The operator may begin to bring the trailer online by entering a command in the user interface of the docking station for the trailer to enter into a standby mode (Standby Process 525). Responsive to the operator entering a command in the user interface of the docking station to call for water to be delivered to the trailer, the trailer performs an initial rinse (Rinse Process 530). Once the rinse is complete, the trailer may be brought into service to begin treating feed water and delivering processed water back to the docking station for delivery to a point of use at the service site (Service Process 535). During the service process, the operator may suspend the water treatment and delivery process by entering a command in the user interface of the docking station for the trailer to re-enter the standby mode or the offline mode. Prior to and/or while performing the service process, a predictive algorithm run by the docking station and/or remote central monitoring system in communication with the docking station calculates a predicted time until exhaustion of one or more treatment units in the trailer. When the predicted time to exhaustion has elapsed or expired, the trailer enters into Exhausted Process 540. An operator may perform a verification of exhaustion of the one or more treatment units of the trailer, for example, by taking manual measurements of one or more parameters of the processed water (act 545). If the verification of exhaustion fails, the trailer returns to the offline mode. If the verification process succeeds, the service run of the trailer is closed (act 550), the operator enters a command in the user interface of the docking station to set the operation mode of the trailer to Offline and its state to Disconnected and the operator then proceeds to disconnect the trailer from the docking station (act 555.)

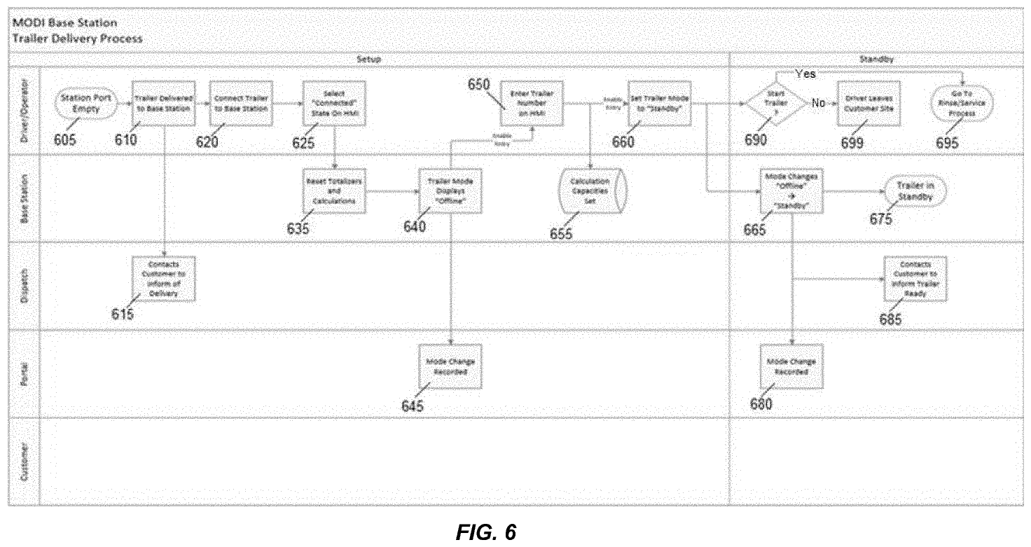

A process flow diagram for a delivery process of a mobile water treatment trailer to a docking station at a service location is illustrated in FIG. 6. The process begins at 605 with the ports of the docking station being empty and unconnected to a trailer. At act 610 a trailer is delivered to the docking station at the service location. A dispatcher of a service provider responsible for the trailer informs the customer responsible for the service location of the delivery of the trailer in act 615. In act 620 the trailer is connected to the water inlet and outlet of the docking station. An operator accesses the user interface of the docking station end enters a command to set the state of the trailer to “Connected” in act 625. Any flow data or capacity calculations remaining in the docking station from any previously connected trailer are reset in act 635. At this point the trailer is still considered offline and this may be displayed in the user interface of the docking station in act 640. The setting of the operation mode of the trailer to “Offline” is recorded in the portal (act 645) and may be communicated from the docking station to a remote central monitoring system. It should be understood that in various embodiments, the “portal” illustrated in FIGS. 6-8 corresponds to a remote central monitoring system, for example, the remote central monitoring system 200 illustrated in FIG. 1D. In act 650 the operator accesses the user interface of the docking station end enters an identifier, for example, the identifier number of the trailer, optionally along with a user identification or other login credentials of the operator. In act 655 the remaining treatment capacity of the trailer is obtained, for example, from the remote central monitoring system. The obtained remaining treatment capacity of the trailer is set as an initial remaining treatment capacity in a predictive model for time to exhaustion of the treatment capacity of the trailer at one or both of the docking station or remote central monitoring system. The operator may enter a command in the user interface of the docking station to change the operating mode of the trailer to “Standby” in act 660. The operating mode of the trailer is changed from “Offline” to “Standby” in act 665 and this mode change is recorded in the portal (act 680) and may be communicated from the docking station to the remote central monitoring system. The trailer assumes the standby mode (act 675) and the customer is informed that the trailer is ready in act 685. In act 690 the trailer is activated to start providing processed water to a point of use at the service location. The trailer begins operation by first performing a rinse and then starts to provide processed water at act 695. The trailer delivery process is complete, and the driver/operator may depart from the service location (act 699).

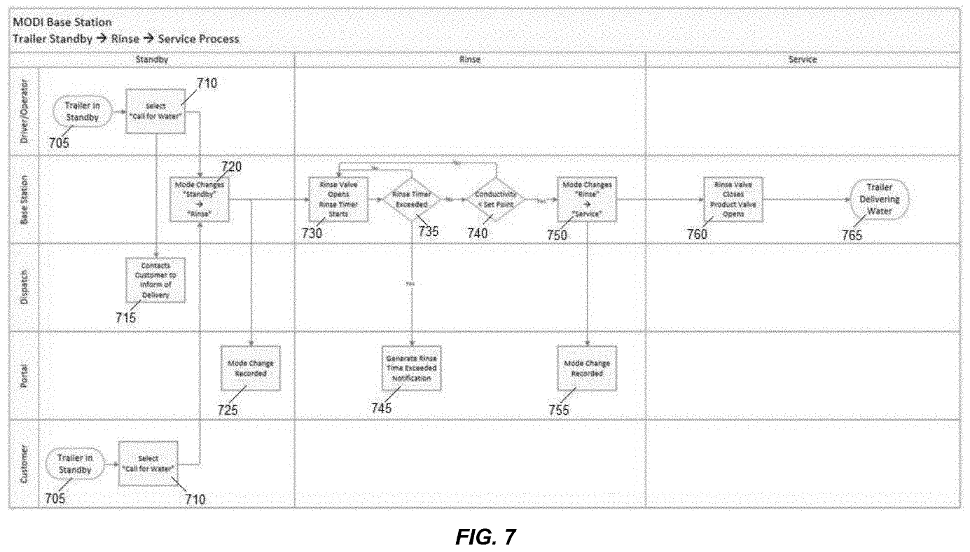

A process flow diagram for a service process of a mobile water treatment trailer coupled to a docking station at a service location is illustrated in FIG. 7. The process begins with the trailer coupled to the docking station in a standby state (acts 705). In act 710 one of an operator of the service provider for the trailer or the customer responsible for the service location enters a command for “Call for Water” either at the user interface of the docking station or from a remote location. If the operator was the one who entered the “Call for Water” command, the operator informs the customer in act 715 that the trailer will begin delivery of processed water to the point of use at the service location. In act 720 the operation mode of the trailer changes from “Standby” to “Rinse” and this mode change is recorded in the portal and may be communicated from the docking station to a remote central monitoring system (act 725). In act 730 a rinse valve of the trailer is opened and a rinse of the internal water treatment systems and conduits of the trailer is initiated. The rinse is performed until either a rinse timer is exceeded (act 735) or the conductivity of the rinse water exiting the trailer drops below a set point (act 740). If the conductivity of the rinse water exiting the trailer fails to reach the setpoint before the rinse timer expires a warning may be generated (act 745). After the rinse is completed the operating mode of the trailer is changed from “Rinse” to “Service” (act 750). This mode change is recorded in the portal and may be communicated from the docking station to a remote central monitoring system (act 755). In act 760, the rinse valve of the trailer is closed and the product water valve opened. The trailer then begins to deliver processed water to the point of use at the service location (act 765).

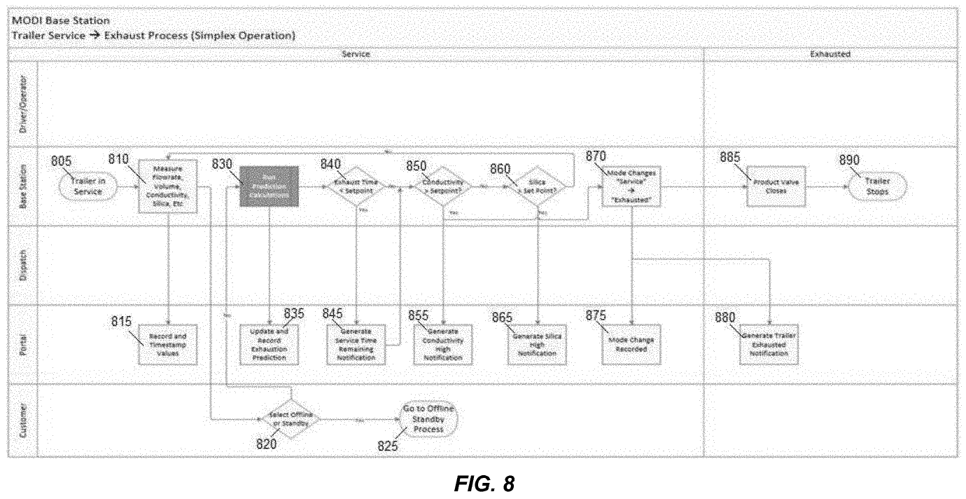

A process flow diagram for an exhaustion process of a mobile water treatment trailer coupled to a docking station at a service location is illustrated in FIG. 8. The process begins at act 805 with the trailer coupled to the docking station and delivering processed water to a point of use at the service location. As the trailer is producing and delivering the processed water to the point of use water quality parameters of the processed water and/or feed water being delivered to the trailer, for example, flow rate, volume, conductivity, silica content, etc. are measured by the respective sensors of the docking station (act 810). These measurements of the water quality parameters are time stamped and saved in a memory of the docking station or portal and/or communicated to a remote central monitoring system (act 815). If, during operation of the trailer for delivery of the processed water an operator or a customer responsible for the service site enters a command, either through the user interface of the docking station or remotely, for the trailer to enter a standby or offline state (act 820), the trailer transitions from the “Service” mode to the standby or offline mode (act 825).

As the trailer is producing and delivering the processed water to the point of use calculations for time remaining until exhaustion of one or more treatment units in the trailer are performed by the docking station, remote central monitoring station, or both (act 830). As these calculations are performed the predicted remaining time until exhaustion is updated either continuously or periodically and the predicted remaining time until exhaustion is recorded in a memory of the docking station or portal and/or the remote central monitoring system (act 835). In act 840 the docking station determines if the predicted time until exhaustion has dropped below a predefined setpoint. If so, a warning regarding service time remaining is generated by the docking station or portal (act 845). The docking station also checks to see if the conductivity of the processed water is above a predetermined setpoint (act 850). If so, a warning regarding the conductivity of the processed water being too high is generated by the docking station or portal (act 855) and the operating mode of the trailer is changed from “Service” to “Exhausted” (act 870). This change in operating mode is recorded in the portal (act 875) and may be communicated from the docking station to the remote central monitoring system. Additionally, a notification that the trailer has been exhausted is generated by the docking station or portal (act 880). The product water valve of the docking station is closed (act 885) and the production and delivery of processed water by the trailer stops (act 890).

If, in act 850, the conductivity of the processed water is determined to be acceptable, the docking station checks whether the silica concentration of the processed water is above a predetermined setpoint (act 870). If so, a high silica warning is generated the docking station or portal (act 865) and the warning may be communicated to the remote central monitoring system.

If the monitored water quality parameters checked in acts 850 and 860 are acceptable, the process returns to act 810 and the trailer continues to generate and deliver processed water to the point of use and the water quality parameters and predicted time to exhaustion continue to be checked.

As discussed above, the processor 165 of the controller 150 of a docking station or a remote central monitoring system may employ one or more predictive models or algorithms, for example, as disclosed in U.S. patent application Ser. No. 16,358,190 to predict remaining capacity and time to exhaustion of ion exchange units in mobile water treatment systems such as mobile water treatment trailers. In some embodiments, the predictive model uses information about the feed water and the connected mobile deionization trailer to predict time to exhaustion. The prediction can be based on historical data and/or direct conductivity measurements of the feed and/or processed water. In some embodiments, the predictive model uses feed water flow rate, conductivity, free mineral acidity, percent alkalinity of anions, free carbon dioxide concentration, and reactive silica concentration data, where available. In some embodiments, the predictive model uses resin volumes for different types of resin included on the trailer, and nominal exchange capacities based upon standard chemical regeneration dosages. The predictive model may determine which resin beds will exhaust first: cation or anion. The predictive model incorporates information regarding the capacity of weak base resin (if present) and external decarbonator (if present) to determine which resin beds will exhaust first. The predictive model may estimate a time to exhaustion based upon current flow rate and other flow rates derived from prior flow demand. The predictive model estimated time to exhaustion may be determined considering the quality endpoints for product conductivity and (where specified) product reactive silica concentration. An embodiment uses the predicted time to exhaustion and the average travel time to the regeneration center to create notifications sufficiently in advance of exhaustion, such that replacement trailers can be delivered as needed, without excessive time sitting in standby.

In some embodiments, a docking station as disclosed herein may provide redundant capabilities (beyond those on the mobile deionization trailer) to alarm and stop the flow of water if the mobile deionization trailer feed or effluent is of insufficient quality. The docking station may stop the flow of water if product water conductivity or product water reactive silica concentrations exceed contractual limits and a time delay expires. In some embodiments, the time delay is provided to assure that the quality change is not a momentary excursion, and the quality change is sustained long enough to warrant control action. Without a time delay as described a quality reading oscillating around a control point might cause excessive control response actions and instability in operation. The time delay may smooth the response to make sure control action is not taken until there is sufficient confidence that it is necessary. In various embodiments, the delay time is configurable.

In some embodiments, a docking station as disclosed herein may include automated valves for service shutoff and to divert product to drain. Embodiments of the docking station may allow water to be diverted to drain during a rinse step.

In some embodiments, a docking station as disclosed herein may include a human-machine interface (HMI) which guides and logs on-site operator interactions. The HMI may require the operator to enter an authentication code before they can access configuration and control functions. The HMI may allow the operator to indicate when a trailer has been connected to the docking station. In some embodiments, service run calculations and totalizers are reset when a new trailer is connected to the docking station. The HMI may allow the operator to identify which trailer has been connected to the docking station.

In some embodiments, resin volumes and capacities used by the docking station and/or remote central monitoring system for calculations of predicted time until exhaustion of one or more treatment units of a newly connected mobile deionization trailer are reset when the newly connected mobile deionization trailer is identified. The docking station and/or remote central monitoring system may obtain nominal resin volumes and capacities from a lookup table, using the type and unique asset identification for the connected mobile deionization trailer.

In some embodiments, a docking station as disclosed herein may allow a connected trailer to be manually advanced from offline to standby. The trailer may be advanced from standby to a pre-service rinse based upon a demand-for-water signal or by turning on a demand-for-water switch in the HMI. The docking station may automatically advance a trailer from rinse to service if required product water quality, for example, conductivity, is obtained within a preset time while rinsing is being performed.

In some embodiments, a docking station as disclosed herein may automatically advance a trailer from a service mode of operation to an exhausted mode of operation if product water quality is outside preset limits for longer than a preset period.

In some embodiments, a docking station as disclosed herein may record instrument readings and timestamps at preset intervals and when exceptional changes are detected. The docking station may record discrete operating states and timestamps whenever a state change is detected. The docking station may record the change and timestamp whenever the operation type, trailer connection status, or operating mode is changed manually or automatically.

In some embodiments, a docking station as disclosed herein may record authenticated operator ID code when changes are manually initiated.

Data specific to the local operation of embodiments of a docking station as disclosed herein may be transmitted to a central database, from which it can be viewed and exported by authorized users via a web portal user interface.

In some embodiments, a docking station as disclosed herein may generate email and/or SMS notifications for excessive feed water ORP or turbidity. The docking station may generate email and/or SMS notifications for excessive rinse time and for excessive calculated % exhaustion. The docking station may generate email and/or SMS notifications for excessive product conductivity and/or for excessive product reactive silica concentration, when maintenance is due soon or when maintenance activity is overdue, if flow is detected when there should not be any flow, or if the docking station fails to send data after a minimum expected check-in interval.

In some embodiments, a docking station as disclosed herein may allow up to four trailers to be docked simultaneously, and operated in parallel or alternating service, with a configurable quantity of trailers and order of selection for trailers moving into and out of service.

In some embodiments, a docking station as disclosed herein may require HMI verification that a service run has been completed, before advancing a trailer from exhausted mode to offline mode, logging final values and timestamp, and allowing the trailer to be disconnected.

In some embodiments, data generated by a docking station as disclosed herein may be accessible via a web portal by authorized users and allow easy comparison of mobile deionization trailer performance versus nominal capacity expectations and performance of other trailers with the same nominal capacity, such that resin volumes, regeneration dosages and/or resin bed replacement frequency can be optimized to achieve consistent capacity in accordance with expectations.

In various embodiments, a docking station located at a facility and/or a remote centralized monitoring station may perform calculations to predict the time to exhaustion of ion exchange media in a trailer at the facility. The calculations may utilize the variables presented in Table 1 below:

TABLE 1

| | | | |
|---|---|---|---|
| Strong Acid Cation | Weak Base Anion | Strong Base Anion | Mixed Bed |
| Target Resin | Target Resin | Target Resin | Target Resin |
| Volume, ft³ | Volume, ft³ | Volume, ft³ | Volume, ft³ |
| V_{SA} | V_{WB} | V_{SB} | V_{MB} |
| Target SAC | Target WBA | Target SBA | Target MB |
| Volumetric Capacity, | Volumetric Capacity, | Volumetric Capacity, | Volumetric Capacity, |
| kilograins/ft³ | kilograins/ft³ | kilograins/ft³ | kilograins/ft³ |
| Ċ_{SA} | Ċ_{WB} | Ċ_{SB} | Ċ_{MB} |
| Target SAC Installed | Target WBA Installed | Target SBA Installed | Target MB Installed |
| Capacity, kilograins | Capacity, kilograins | Capacity, kilograins | Capacity, kilograins |
| C_{SA} = V_{SA} × Ċ_{SA} | C_{WB} = V_{WB} × Ċ_{WB} | C_{SB} = V_{SB} × Ċ_{SB} | C_{MB} = V_{MB} × Ċ_{MB} |

The incoming ion exchange load for the mobile deionization system is calculated by multiplying an increment of volumetric flow, F (in kilogallons), by average concentrations of exchangeable or ionizable species, and converting concentration measurements to kilograins per kilogallon (or grains per gallon). The concentration of cations or the strong acid cation resin loading rate is calculated from conductivity measurement using the following formula:

\dot{M}_{SA}=Conductivity (μS/cm@25° C.)×(conductivity TDS conv)/(grains conversion) (1)

Where conductivity TDS cony is a settable factor for converting μS/cm to ppm as CaCO₃ (typically in the range of 0.5 to 0.7) and grains conversion is a constant conversion factor equal to 17.12 ppm CaCO₃ per grain per gallon.

If no decarbonator or weak base anion resin is present, the strong base anion loading rate is calculated as follows:

\dot{M}_{SB}=\dot{M}_{SA}+(ppm dissolved CO₂ as CaCO₃+ppm reactive SiO₂ as CaCO3)/(grains conversion) (2)

Carbon dioxide is converted into bicarbonate ions at the higher pH values generated as exchange occurs in the strong base anion (SBA) tank; this and reactive silica will add to the anionic load associated with the feed conductivity.

The loading on the strong base anion exchange resin can be reduced by preceding the SBA tanks with either some weak base anion resin tanks or by flow diversion to an external decarbonation process.

In embodiments where weak base anion tanks are employed, these exchangers can remove anionic species associated with Free Mineral Acidity (FMA). These are the anionic dissociation products from strong acids (nitric, sulfuric, hydrochloric), i.e. nitrates, sulfates and chlorides. Weak base anion (WBA) resin has a high volumetric capacity and can be an effective use of trailer space when treating waters with high FMA.

Until the weak base anion installed capacity is exhausted, the anionic loading rate on the WBA units and corresponding reduction in loading rate on the SBA units is calculated as follows:

\dot{M}_{WB}=\dot{M}_{SB,0}×% FMA/100=(ppm NO₃_{^{−}}+ppm SO₄⁼+ppm Cl⁻)/(grains conversion) (3)

As the individual anion concentrations are not typically measured with online instrumentation, the % FMA can be entered for a specific site as a single input (using lab water analysis data).

The effluent of the strong acid cation (SAC) exchanger (prior to exhaustion) will have a low pH value, and all alkalinity in the feed water will essentially be converted to dissolved carbon dioxide at that point in the treatment process. If an external means of decarbonation is available, the SAC effluent can be diverted and the load to the anion tanks subsequently reduced. To a good approximation on all waters except those with very low TDS, this essentially removes all the alkalinity loading on the SBA:

\dot{M}_{SB}=\dot{M}_{SB,0}×% Alk/100=(ppm CO₂+ppm HCO₃_{^{−}}+ppm CO₃⁼)/(grains conversion) (4)

Based upon the different installed capacities in various mobile deionization trailers and the different loading rates of various waters, the tanks that should exhaust first can be predicted. In some cases, it will be the cation tanks, and in others it will be the anion tanks. If WBA tanks are installed and they exhaust first, the SBA tanks can remove excess FMA and may still outlast the SAC tanks. Once SAC or SBA capacity is exhausted, excess ionic load is passed to the mixed bed tanks, which include additional SAC and SBA resin in controlled proportion.

Typically, C_{MB} is a relatively small portion of the total trailer capacity, and the trailer will deliver poor effluent quality soon after the SAC or SBA exhausts. But in some trailer designs, the mixed bed (MB) capacity is significant enough to be considered in the overall trailer capacity, and it provides additive capacity for both cation and anion exchange.

In addition, silica is weakly held by anion resin, and will begin to come off the mixed bed tanks before any increase in conductivity is detected. In cases where there is an effluent silica specification, the overall trailer capacity is de-rated by an adjustable factor, SDR≤1.

Both the flow rate and the feed water chemistry can change during a mobile deionization service cycle. The predictive algorithm compares the accumulated cation and anion exchange capacities consumed to the theoretical capacities available. An estimated % exhaustion is determined based upon the type of resin (cation or anion) that appears to have the highest percentage of its capacity consumed.

% Trailer Exhausted=MAX (% SAC Exhausted, % SBA Exhausted) (5)

The percent capacity consumed for strong acid cation resin is calculated as follows:

% SAC Exhausted=Σ(F×average \dot{M}_{SA})/(C_{SA}+C_{MB})×100 (6)

If there is no WBA present, the percent capacity consumed for SBA resin is calculated as follows:

% SBA Exhausted=Σ(F×average \dot{M}_{SB})/(C_{SB}+C_{MB})×100 (7)

If there is WBA present, the percent capacity consumed for WBA resin is calculated as follows:

% WBA Exhausted=Σ(F×average \dot{M}_{WB})/(C_{WB})×100 (8)

Once this accumulates to 100%, FMA is no longer subtracted from the subsequent load on the SBA resin.

Estimated service time remaining, based on total run time or non-standby time is calculated as follows:

ESTR=Elapsed Time/(% Trailer Exhausted/SDR)−Elapsed Time (9)

The system can be configured to notify dispatch when the estimated service time remaining reaches certain thresholds, and these can be configured based upon the distance between the customer site and the nearest mobile deionization service facility or supply depot.

Data analysis for a customer site can be used to compare service runs for mobile deionization trailers of the same type. This analysis can help identify trailers that have resin volumes or volumetric capacities that fall outside specified limits, or it can identify other quality issues with resin regeneration that cause a trailer to not perform comparably to similar trailers or historical benchmarks.

As many customer sites have limited variation in feed water chemistry, data analysis for multiple mobile deionization service runs at a site can also be used to continuously improve the predictive model, including values for adjustable constants, incorporation of new variables, or other changes to the predictive algorithm.

As asset performance variability is reduced and the predictive model is improved, analysis of the data can help make sure the mobile deionization assets employed at the customer site are the best possible fit for the customer needs. Ideally the treatment process and the allotment of resins on the assets deployed will be such that resin utilization is maximized and cation and anion resins reach a similar degree of exhaustion prior to each exchange.

The size of the trailer deployed, or the total resin volume can also be matched against customer usage history such that larger capacity trailers are more readily available for customers who have the highest demand. Customers who require a lower frequency of exchanges or standby capacity only for extended periods can have their needs satisfied with smaller assets until such time as their demand increases.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A docking station at a service site fluidly connectable to a mobile water treatment system having one or more deionization units comprising:
a fluid inlet configured to receive a processed water from the mobile water treatment system and a fluid outlet configured to deliver the processed water to a point of use;
a monitoring system configured to monitor at least one water quality parameter of the processed water; and
a processor configured to receive the monitored water quality parameter and communicate with a central monitoring system disposed remotely from the docking station regarding the monitored water quality parameter.

2. The docking station of claim 1, wherein the processor is further configured to record the at least one monitored water quality parameter and provide the record to the central monitoring system.

3. The docking station of claim 1, wherein the processor is further configured to uniquely identify the mobile water treatment system.

4. The docking station of claim 3, wherein the processor is further configured to provide to the central monitoring system a representation of a remaining treatment capacity associated with the uniquely identified mobile water treatment system.

5. The docking station of claim 1, wherein the monitoring system is further configured to monitor of at least one of flow rate, conductivity, temperature, and pressure of the processed water.

6. The docking station of claim 5, wherein the monitoring system is further configured to monitor a silica concentration of the processed water.

7. The docking station of claim 5, further comprising a feed water inlet configured to deliver feed water to the mobile water treatment system and a second monitoring system configured to monitor at least one water quality parameter of the feed water.

8. The docking station of claim 7, wherein the at least one water quality parameter of the feed water includes at least one of turbidity, oxidation-reduction potential, flow rate, and conductivity.

9. The docking station of claim 7, configured to suspend delivery of the feed water to the mobile water treatment system responsive to one or more quality parameters of the feed water.

10. The docking station of claim 7, wherein the processor is further configured to determine a predicted time until exhaustion of at least one deionization unit based on the remaining treatment capacity of the at least one deionization unit and the at least one water quality parameter of the feed water.

11. The docking station of claim 10, wherein the processor is further configured to determine the predicted time until exhaustion based further on the feed water flow rate or the processed water flow rate.

12. The docking station of claim 11, wherein the processor is configured to communicate the predicted time until exhaustion to the central monitoring system.

13. The docking station of claim 1, wherein the central monitoring system is configured to compare the predicted time until exhaustion to a transit time for delivery of a second mobile water treatment system to the docking station at the service site.

14. The docking station of claim 13, wherein the processor is configured to send a request for replacement of the mobile water treatment system with the second mobile water treatment system.

15. The docking station of claim 13, wherein the processor is configured to send a request for connection of the second mobile water treatment system to a second docking station located at the same service site as the docking station.

16. The docking station of claim 1, configured to suspend delivery of the processed water in response to one or more water quality parameters.

17. The docking station of claim 16, wherein the processor is configured to control a second docking station to deliver processed water from a second mobile water treatment system connected to the second docking station to the point of use responsive to suspending delivery of the processed water from the mobile water treatment system.

18. The docking station of claim 1, further comprising a user interface, the docking station being configured to only accept a request for delivery of the processed water from the mobile water treatment system to the point of use responsive to a valid user login and a valid mobile water treatment system identification being received through the user interface.

19. A water treatment system comprising:
one or more docking stations in fluid communication with one or more respective points of use;
a central monitoring system remote from and in communication with the one or more docking stations; and
the one or more docking stations each including:
a fluid inlet configured to receive a processed water from a uniquely identifiable mobile deionization trailer and a fluid outlet configured to deliver the processed water to the one or more points of use;
a monitoring system configured to monitor one or more water quality parameters of the processed water; and
a processor configured to communicate with the central monitoring system and receive data regarding remaining treatment capacity of deionization units disposed in the mobile deionization trailer.

20. The system of claim 19, wherein the central monitoring system is configured to provide the data regarding the treatment capacity of the deionization units of one of the uniquely identifiable mobile deionization trailers based on the one or more monitored water quality parameters.

21. The system of claim 20, wherein the processor is configured to determine a predicted time until exhaustion of at least one of the deionization units based on the data regarding a remaining treatment capacity of deionization units, one or more quality parameters of feed water provided to the one of the uniquely identifiable mobile deionization trailer and measured by the monitoring system, and flow rate of one of the feed water or of the processed water.

22. The system of claim 20, wherein the one or more uniquely identifiable mobile deionization trailers include geolocation systems, and further configured communicate their respective location to the central monitoring system.

23. The system of claim 22, wherein the processor is configured to receive information regarding a location of a second mobile deionization trailer from the remote monitoring system and to send a request for delivery of the second mobile deionization trailer based on the predicted time to exhaustion of the deionization units and the location of second mobile deionization trailer.

24. A method of facilitating water treatment at a point of use, the method comprising:
installing a docking station at a site including the point of use, the docking station including a fluid inlet configured to receive processed water from a mobile deionization trailer and a fluid outlet configured to deliver the processed water to the point of use; a monitoring system configured to monitor one or more water quality parameters of the processed water; and a processor configured to communicate with a central monitoring system and receive data regarding remaining treatment capacity of deionization units disposed in the mobile deionization trailer; and
enabling communication between the stationary docking station and the central monitoring system.

25. The method of claim 24, further comprising:
connecting the mobile deionization trailer to the docking station;
providing the docking station with a unique identifier of the mobile deionization trailer;
exchanging information between the docking station and the central monitoring system regarding remaining treatment capacity of deionization units disposed in the mobile deionization trailer; and
providing treated water to the point of use from the mobile deionization trailer through the docking station.

26.-34. (canceled)
